(19) United States
(12) Patent Application Publication
(10) Pub. No.: US 2018/0236676 A1
(43) Pub. Date: Aug. 23, 2018

(54) RAZOR HEAD AND ASSEMBLY METHOD THEREOF

(71) Applicant: Xiangrong Ren, Wenzhou (CN)

(72) Inventors: Chi Ren, Wenzhou (CN); Xiangrong Ren, Wenzhou (CN)

(21) Appl. No.: 15/548,488

(22) PCT Filed: Feb. 4, 2015
(86) PCT No.: PCT/CN2015/072197

§ 371 Date: Aug. 3, 2017

(51) Int. Cl. B26B 21/22; B26B 21/40

(52) U.S. Cl. CPC B26B 21/227; B26B 21/4012; B26B 21/4068

(57) ABSTRACT

A razor head includes housing, razor blades and clamping pieces. The housing includes a front edge, a rear edge, side edges and through holes. The razor blades are located between the front edge and the rear edge, and assembled on the side edge along a first direction and limited to move along the first direction. The clamping piece includes a pressing section and an insertion section, a separation notch is formed on the insertion section to form an expansion portion, the pressing section is stretched due to the expansion portion, the insertion section is restricted to draw from the through hole along an opposite direction of the first direction, the pressing section is pushed against the razor blade, and the razor blade is clamped between the pressing section and the side edge. The assembly is simple and convenient, and the utilization efficiency of the clamping piece is high.

### FIELD OF THE INVENTION

The present invention relates to technical field of shaving, and more particularly to a razor head and an assembly method whose assembly is simple and convenient, and the utilization efficiency of the clamping piece is high.

### BACKGROUND OF THE INVENTION

With improvement of the economy and the society, abounding consumables are offered to people to satisfy people's demand, thereby improving people's standard or living. While razors are one of these consumables.

Currently, the razors have two types including electric razors and manual razors. The manual razors have a large share of the market due to its complete shaving effect and without power source.

Regarding to the manual razors, its razor head includes a housing, one or more razor blades and a clamping piece made of aluminum. The housing has a front surface facing to the skin, a rear surface opposite the front surface, and a top surface and a bottom surface located between the front and rear surfaces. The razor blades are arranged along the length direction of the housing and assembled on the front surface. The clamping piece is across the front surface, one end of the clamping piece is surrounding the top surface and then bent to buckle on the rear surface, and another end of the clamping piece is surrounding the bottom surface and then bent to buckle on the rear surface, thus the housing with the razor blades is clasped by the clamping piece.

However, the clamping piece must be sufficiently big to clamp the front surface, the rear surface, the top surface and the bottom surface. By this token, the material of the clamping piece is much to increase the material cost. Further, since the clamping piece must be bent for several times to surround the surfaces of the housing, thus the assembly process of the clamping piece is complicated and inconvenient.

Thus, there is a need for a razor head with an improved clamping piece to overcome the above-mentioned drawbacks.

### SUMMARY OF THE INVENTION

One objective of the present invention is to provide a razor head with an improved clamping piece, the utilization efficiency of the clamping piece is high, and the assembly is simple and convenient.

Another objective of the present invention is to provide an assemble method of a razor head, the utilization efficiency of the clamping piece is high, and the assembly is simple and convenient.

To achieve the above-mentioned objectives, a razor head includes housing, razor blades and clamping pieces. The housing includes a front edge, a rear edge, side edges and through holes located between the front edge and the rear edge. The razor blades are located between the front edge and the rear edge, and assembled on the side edge along a first direction and limited to move along the first direction by the side edge. The clamping piece includes a pressing section across the razor blade and an insertion section bent from the pressing section, a separation notch is formed on the insertion section to form an expansion portion, the pressing section is stretched due to the expansion portion, the insertion section is restricted by the expansion portion to draw from the through hole along an opposite direction of the first direction, the pressing section is pushed against the razor blade, and the razor blade is clamped between the pressing section and the side edge.

Preferably, after the insertion section is inserted in the through hole, an external object is inserted into the separation notch along the opposite direction of the first direction to extrude and expand the expansion portions, so that the expansion portions are pushed against the inner walls of the through hole.

Preferably, the expansion portions have a first expansion portion and a second expansion portion both of which are expanded away from themselves by means of the external object to cause the first and the second expansion portions to push against the inner walls of the through hole.

Preferably, one end of the through hole away from the pressing section is expanded to form an expansion hole section which has a wider size than other portions of the through hole, and the first and the second expansion portions are pushed against inner walls of the expansion hole section.

Preferably, the inner walls of the expansion hole section include two opposite walls that are inclined outwards.

Preferably, the through holes are located at two sides of the razor blades, and the insertion sections are respectively extended from two ends of the pressing section, with each insertion section is corresponding to each separation notch.

Preferably, the through hole is shaped and sized to match with the insertion section.

Preferably, a receiving space is formed by the front edge, the rear edge and the side edges to accommodate the razor blades, resilient legs with corresponding amount with the razor blades are extended from the side edges toward the receiving space, and movements of the razor blades along the first direction are limited by the resilient legs once the razor blades are assembled on the resilient legs respectively.

An assembly method of a razor head includes steps of:

(1) providing the housing, the razor blades and the clamping piece;

(2) assembling the razor blades on the housing along the first direction;

(3) moving the clamping piece along the first direction to make the insertion section of the clamping piece to insert into the through hole; and

(4) extruding the expansion portions along the opposite direction of the first direction to expand the expansion portions toward the inner walls of the through hole, until the pressing section is stretched and the insertion section is prevented from being drawn from the through hole.

Preferably, in the step (4), an external object is inserted into the separation notch along the opposite direction of the first direction to extrude the separation notch, and the expansion portions are expanded due to the external object, until the expansion portions are pushed against the inner walls of the through hole.

In comparison with the prior art, since the through hole is located between the front edge and the rear edge, and the clamping piece has a pressing section across the razor blades and an insertion section bent from the pressing section and inserted into the through hole along the first direction, a separation notch provided on the insertion section and extended through an end of the insertion section along the first direction to form an expansion portion which is expanded toward inner walls of the through hole, the pressing section is stretched by means of the expansion portion, and the insertion section is restricted by the expansion portion to draw from the through hole along an opposite direction of the first direction, thus the pressing section is pushed against the razor blade, thereby the razor blade is clamped between the pressing section and the side edge. Since the razor blades are clamped by the clamping piece by means of the expansion portion pushing against the inner walls of the through hole, thus the assembly of the clamping piece and the housing is simple and convenient. Furthermore, the material of the clamping piece is reduced because only a parts of the razor blades which are located at the front edge and the rear edge is clasped, thus the utilization efficiency of the clamping piece is improved to reduce material cost.

### BRIEF DESCRIPTION OF THE DRAWINGS

The accompanying drawings facilitate an understanding of the various embodiments of this invention. In such drawings:

FIG. 1 is a perspective view of a razor head according to a first embodiment of the present invention;

FIG. 2 is a bottom view of the razor head of FIG. 1;

FIG. 3 is a cross-sectional view along the line A-A in FIG. 2;

FIG. 4 is a perspective view of the razor head of FIG. 3;

FIG. 5 is a perspective view of a clamping piece of the razor head;

FIGS. 6a-6d are assembling flowchart of the razor head according to an embodiment of the present invention; and

FIG. 7 is a flow chart of assembling a razor head according to an embodiment of the present invention.

### DETAILED DESCRIPTION OF ILLUSTRATED EMBODIMENTS

A distinct and full description of the technical solution of the present invention will follow by combining with the accompanying drawings.

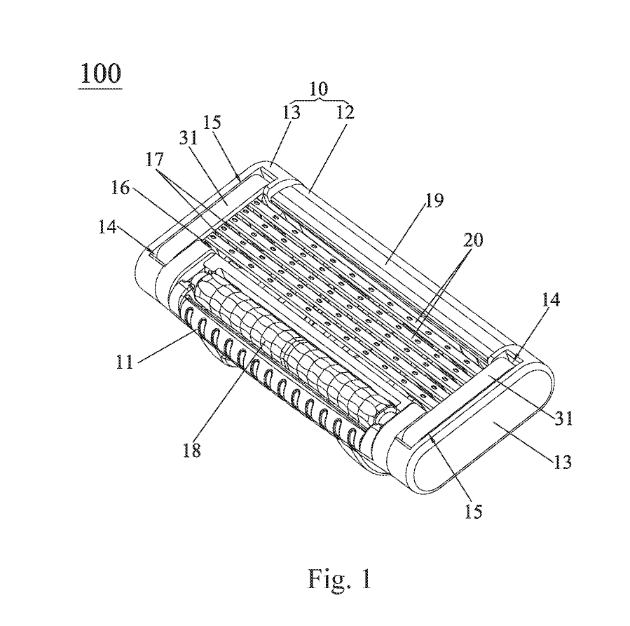

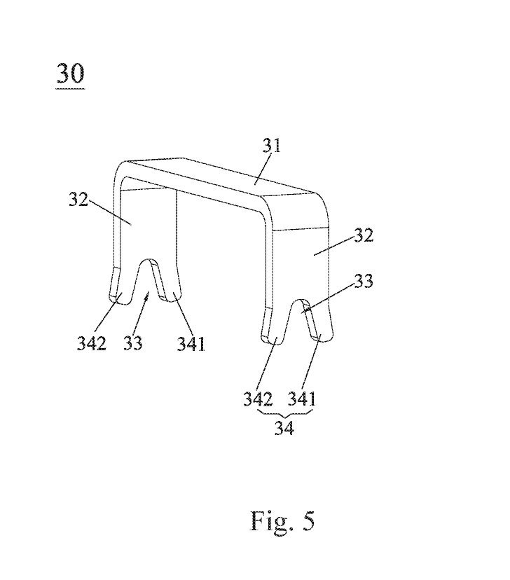

Referring to FIGS. 1-5, a razor head 100 according to the present invention includes a housing 10, one or more razor blade 20 and clamping pieces 30. Specifically, the amount of the razor blade 20 is five in the present embodiment, but also can be one, two, three, four or six, etc., which is not limited.

As shown in FIGS. 1-4, the housing 10 includes a front edge 11, a rear edge 12, side edges 13 extended between the front edge 11 and the rear edge 12, and through holes 14 located between the front edge 11 and the rear edge 12. Specifically, two through holes 14 are arranged at two sides of the razor blades 20 along a direction across the razor blades 20, so that the razor blades 20 are located between the through holes 14, as shown in FIG. 1. Preferably, the through holes 14 are formed on the front edge 11 and the rear edge 12 respectively, and a receiving space 16 is formed by the front edge 11, the rear edge 12 and two side edges 13 to accommodate the razor blades 20. More preferably, the through holes 14 are shaped and sized to match with the insertion section 32, in order to make the insertion section 32 be inserted into the through hole 14 reliably. The size of the insertion section 32 is matched with the size of the through holes 14 means that, both the thickness and the width of the insertion section 32 are smaller than or equal to the diameter of the through holes 14.

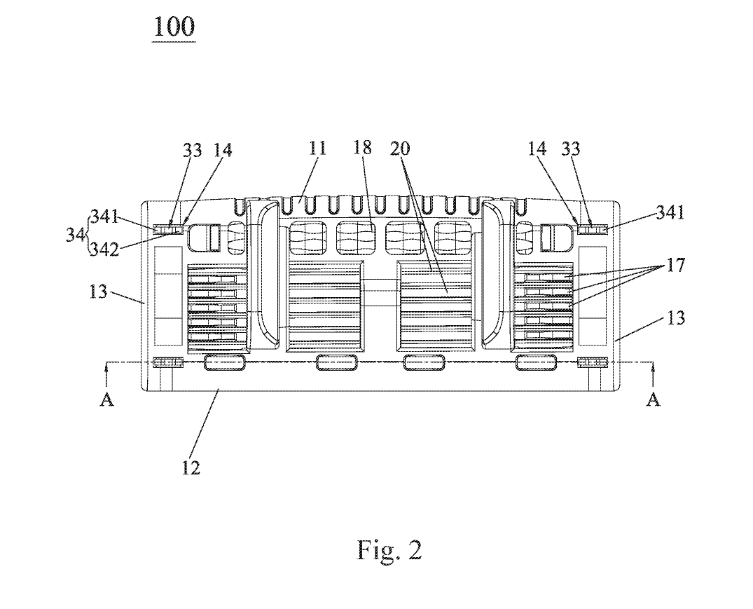

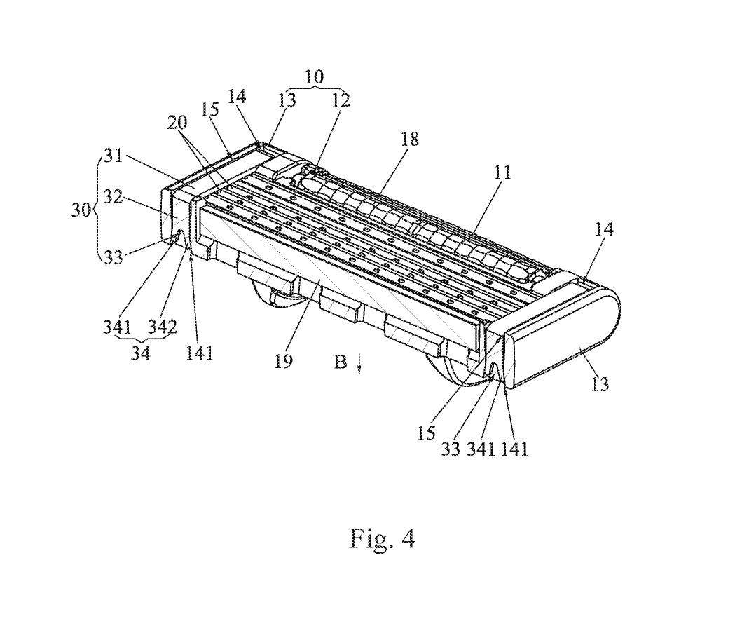

Referring to FIG. 2 again, the razor blades 20 are located between the front edge 11 and the rear edge 12, the razor blades 20 are assembled on the side edges 13 along a first direction, and the movement of the razor blades 20 along the first direction is restricted by the side edges 13. Specifically, in this embodiment, the first direction is a direction from up to bottom along the housing 1, namely the arrow B in FIG. 4. Of course, the first direction also can be from bottom to up along the housing 1. An upward direction of said housing 10 means that side facing to the human skin, while a downward direction said housing 10 means that side opposite to the human skin. The front edge 11 mentioned above means that edge which is close to the human skin during the shaving, while the rear edge 11 mentioned above means that edge which is far from the human skin during the shaving.

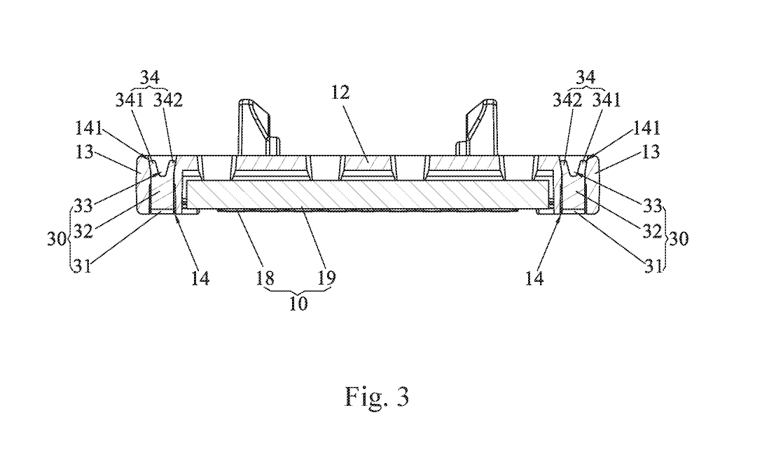

As shown in FIGS. 3-5, the clamping piece 30 includes a pressing section 31 and insertion sections 32 bent from the pressing section 31 along the first direction and inserted into the through holes 14. Preferably, the insertion sections 32 are substantially perpendicular to the pressing section 31 respectively. A separation notch 33 is formed on each insertion section 32 and extended along the first direction at the end of the insertion section 32, as a result, an expansion portion 34 (as shown in FIG. 3, 4 or 5) is formed and expanded toward inner walls of the through hole 14. Once the pressing section 31 is stretched by the expansion portion 34, the insertion section 32 is prevented from being drawn from the through hole 14 along the opposite direction of the first direction. The pressing section 31 is for pressing against the razor blades 20 along the first direction, so that the razor blades 20 can be clamped between the pressing section 31 and the side edge 13, thereby the razor blades 20 can be quickly fixed on the housing 10 by means of the clamping pieces 30.

For ensuring the razor blades 20 to make adaptive elastic deformation during the shaving process to fit with the skin, resilient legs 17 with corresponding amount with the razor blades 20 are extended from the side edges 13 toward the receiving space 16. Once the razor blades 20 are respectively assembled on the resilient legs 17 along the first direction, movements of the razor blades 20 along the first direction are limited. For guiding the razor blades 100 during the shaving process, a guide roller 18 is installed on the front edge 11 and in a longitudinal arrangement along the housing 10. For providing lubrication effect during the shaving process, a lubrication tape 19 is installed on the rear edge 12 and in a longitudinal arrangement along the housing 10.

Preferably, the lubrication tape 19 is parallel to the guide roller 18. In order to correspond to the through holes 14 at two sides, two ends of the pressing section 31 are provided with one insertion section 32, and each insertion section 32 is provided with one separation notch 33. More preferably, the pressing section 31 and the insertion sections 32 are integrated in a one-piece structure to enhance the clamping effect of the clamping pieces 30. Preferably, the clamping pieces 30 can be made of metal such as stainless steel, copper, aluminum alloy or aluminum, etc., or nonmetal such as plastic, etc.

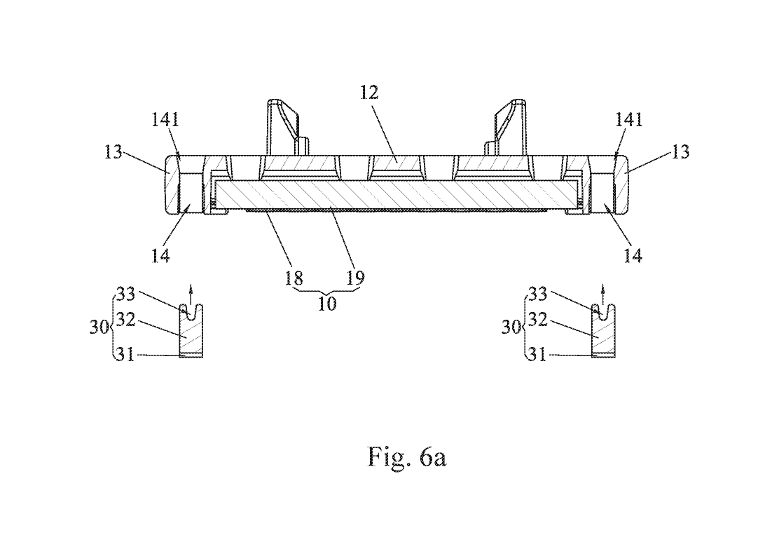

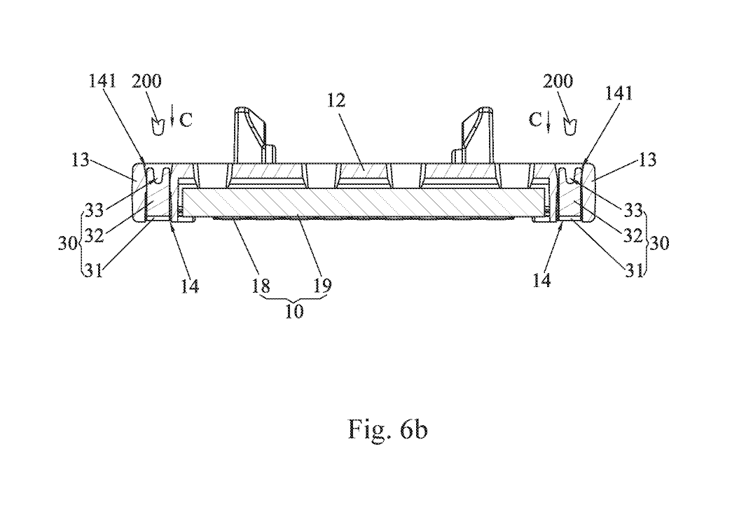

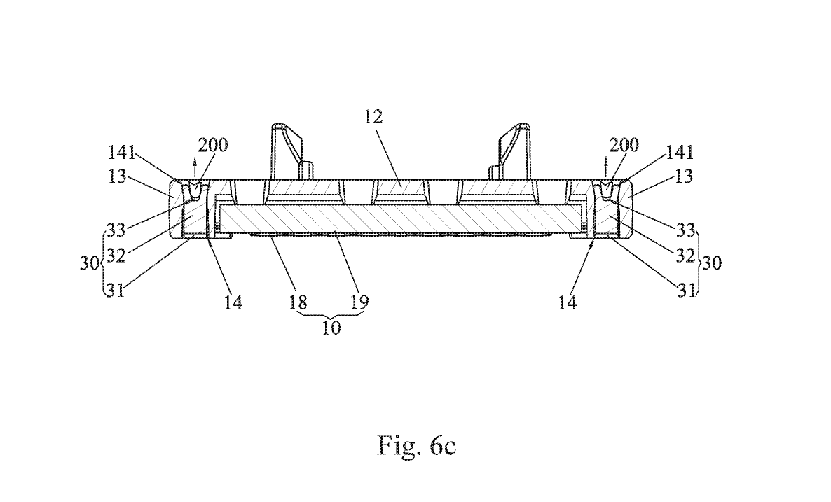

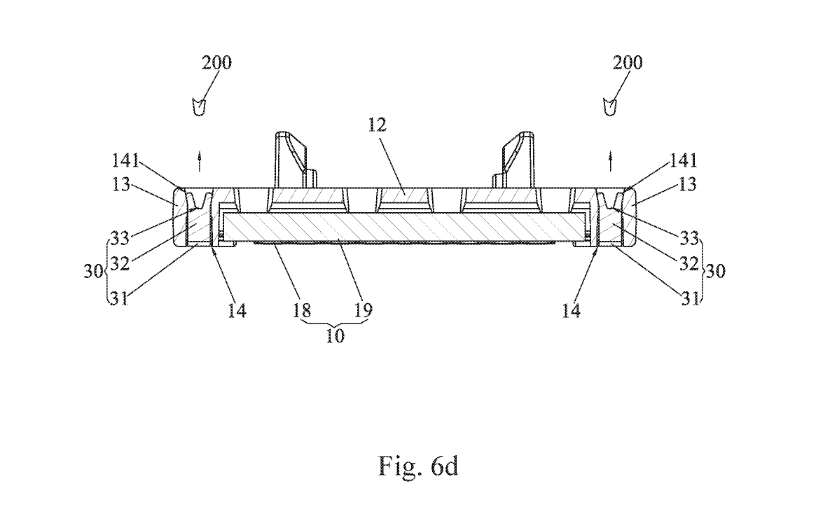

As shown in FIGS. 6a-6c, after the insertion sections 32 are inserted into the through holes 14 along the first direction, the status is as shown in FIG. 6b; in this position, an external object 200 (such as a pushing head) is inserted into the separation notch 33 along an opposite direction of the first direction (namely the arrow C indicated in FIG. 6b), such that the expansion portion 34 is extruded to expand within the through hole 14, as shown in FIG. 3, 4 or 6c. Therefore, the pressing section 31 will be stretched due to the force from the external object 200, and the insertion section 32 will be prevented from being drawn from the through hole 14 along the opposite direction (arrow C) of the first direction. Preferably, the expansion portion 34 includes a first expansion portion 341 and a second expansion portion 342, both of which are extruded to expand far from themselves by means of the external object 200, as shown in FIG. 6c, in such a way, it's easy and quick to fix the expansion portion 34 within the through hole 14, and the clamping piece 30 is prevented from being drawn along the opposite direction of the first direction. More preferably, one end of the through hole 14 away from the pressing section 31 is expanded to form an expansion hole section 141 which has a wider size than other portions of the through hole 14, and the first and the second expansion portions 341 and 342 are pushed against the inner walls of the expansion hole section 141, so that the clamping piece 30 is stably received and installed in the expansion hole section 141. Alternatively, the inner walls of the expansion hole section 141 include two opposite walls that are inclined outwards, so as to make the expansion portions 341 and 342 to match with the inclined opposite walls to ensure the stability.

As shown in FIG. 4, the housing 10 further includes grooves 15 which are formed on the front edge 11, the rear edge 11 and the side edges 13 respectively to receive the pressing sections 31, so that the plane of the pressing section 31 is slightly lower than the side edge 13, thus the pressing sections 31 may not be collided during the shaving process to weaken the clamping effectiveness of the clamping pieces 30.

Referring to FIGS. 6a-6c, the assembly process of the razor head follows. After the razor blades 20 are assembled on the housing 1 along the first direction, the insertion sections 32 of the clamping pieces 30 are inserted into the through holes 14 respectively along the direction indicated as the arrow in FIG. 6a, and the status is as shown in FIG. 6b. And then, the external object/tool 200 is inserted into the separation notches 33 along the direction indicated as the arrow C in FIG. 6b, so as to extrude the separation notches 33 to expand the expansion portions 34 so that the expansion portions 34 are pushed against the inner walls of the through holes 14 respectively, as shown in FIG. 6c. In such a way, the pressing portions 31 are stretched, and the insertion portions 32 are prevented from being drawn from the through holes 14 along the opposite direction of the first direction. In detail, the first and the second expansion portions 341 and 342 are expanded to push against the expansion hole section 141. Finally, the external object 200 is removed along the arrow in FIG. 6c to finish the assembly process of the razor head 100, as shown in FIG. 6d.

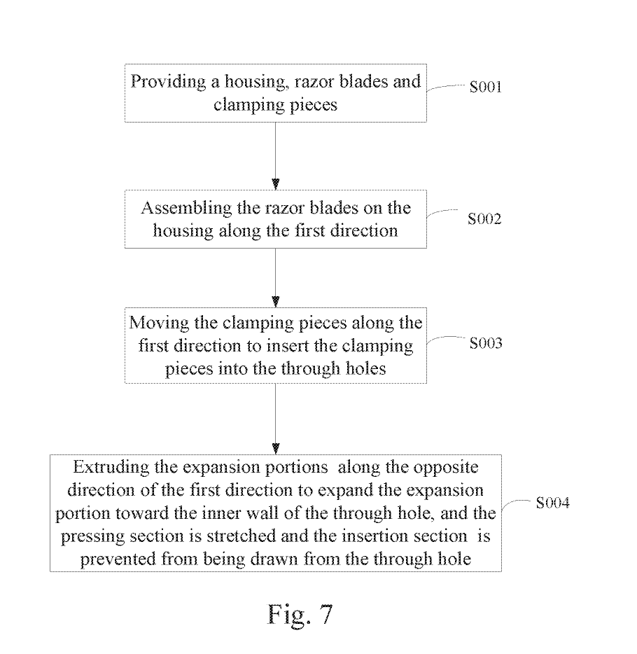

Referring to FIG. 7, the assembling method of a razor head according to the present invention includes the following steps:

S001, providing a housing 10, razor blades 20 and clamping pieces 30;

S002, assembling the razor blades 20 on the housing 10 along the first direction. Specifically, the razor blades 20 are assembled on the resilient legs 17 of the housing 10, so that the razor blades 20 are obstructed by the resilient legs 17 to limit movements along the first direction.

S003, moving the clamping pieces 30 along the first direction to insert the clamping pieces 30 into the through holes 14.

S004, extruding the expansion portions 34 along the opposite direction of the first direction to expand the expansion portion 34 toward the inner wall of the through hole 14, so that the pressing section 31 is stretched and the insertion section 32 is prevented from being drawn from the through hole 14. In this time, the pressing sections 31 are pressed against the razor blades 20 at the top, and the razor blades 20 are pressed by the resilient legs 17 at the bottom, thereby the razor blades 20 are clamped between the pressing sections 31 and the resilient legs 17. Specifically, in the step S004, as shown in FIG. 6b, the external object/tool 200 (such as a pushing head) is inserted into the separation notch 33 along the opposite direction of the first direction, so as to expand the expansion portion 34 until the expansion portion 34 is pushed against the inner walls of the through hole 14, as shown in FIG. 6c. Thus the insertion section 32 can be received in the through hole stably and limited to move from the through hole 14. Once the expansion portion 34 is pushed against the inner walls of the through hole 14, the external object 200 is removed along the first direction, in such a way, the assembly process of the razor head is finished.

In comparison with the prior art, since the through holes 14 are located between the front edge 11 and the rear edge 12, and the clamping piece 30 has a pressing section 31 across the razor blades 31 and an insertion section 32 bent from the pressing section 31 and inserted into the through hole 14 along the first direction, a separation notch 33 is provided on the insertion section 32 and extended through an end of the insertion section 32 along the first direction to form an expansion portion 34 which is expanded toward inner walls of the through hole 14, the pressing section 31 is stretched by means of the expansion portion 34, and the insertion section 32 is restricted by the expansion portion 34 to draw from the through hole 14 along an opposite direction of the first direction, thus the pressing section 31 is pushed against the razor blade 20, thereby the razor blade 20 is clamped between the pressing section 31 and the side edge 13. Since the razor blades 20 are clamped by the clamping piece 30 by means of the expansion portion 34 pushing against the inner walls of the through hole 14, thus the assembly of the clamping piece 30 and the housing 10 is simple and convenient. Furthermore, the material of the clamping piece 30 is reduced because only a parts of the razor blades 20 which are located at the front edge 11 and the rear edge 12 is clasped, thus the utilization efficiency of the clamping piece 30 is improved to reduce material cost.

It should be understood that, as shown in FIGS. 3, 4 and 6b-6d, the insertion sections 32 are received in the through holes 14 respectively, and ends of the insertion sections 32 are not protruded from the through holes.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A razor head comprising:
a housing having a front edge, a rear edge, side edges extended between the front edge and the rear edge, and through holes located between the front edge and the rear edge;
at least one razor blade located between the front edge and the rear edge, and the razor blade being assembled on the side edges along a first direction and being limited to move along the first direction by the side edges; and
a clamping piece, the clamping piece having a pressing section across the razor blade and an insertion section bent from the pressing section and inserted into the through hole along the first direction, wherein a separation notch is provided on the insertion section and extended through an end of the insertion section along the first direction to form an expansion portion which is expanded toward inner walls of the through hole, the pressing section is stretched by means of the expansion portion, the insertion section is prevented from being drawn from the through hole along an opposite direction of the first direction due to the expansion portion, the pressing section is pushed against the razor blade, and the razor blade is clamped between the pressing section and the side edge.

2. The razor head according to claim 1, wherein after the insertion section is inserted in the through hole, an external object is inserted into the separation notch along the opposite direction of the first direction to extrude and expand the expansion portions, so that the expansion portions are pushed against the inner walls of the through hole.

3. The razor head according to claim 2, wherein the expansion portions have a first expansion portion and a second expansion portion both of which are expanded away from themselves by means of the external object to cause the first and the second expansion portions to push against the inner walls of the through hole.

4. The razor head according to claim 3, wherein one end of the through hole away from the pressing section is expanded to form an expansion hole section which has a wider size than other portions of the through hole, and the first and the second expansion portions are pushed against inner walls of the expansion hole section.

5. The razor head according to claim 4, wherein the inner walls of the expansion hole section include two opposite walls that are inclined outwards.

6. The razor head according to claim 1, wherein the through holes are located at two sides of the razor blades, and the insertion sections are respectively extended from two ends of the pressing section, with each insertion section is corresponding to each separation notch.

7. The razor head according to claim 1, wherein the through hole is shaped and sized to match with the insertion section.

8. The razor head according to claim 1, wherein a receiving space is formed by the front edge, the rear edge and the side edges to accommodate the razor blades, resilient legs with corresponding amount with the razor blades are extended from the side edges toward the receiving space, and movements of the razor blades along the first direction are limited by the resilient legs once the razor blades are assembled on the resilient legs respectively.

9. An assembly method of the razor head according to claim 1, and the assembly method comprising steps of:
(1) providing the housing, the razor blades and the clamping piece;
(2) assembling the razor blades on the housing along the first direction;
(3) moving the clamping piece along the first direction to make the insertion section of the clamping piece to insert into the through hole; and
(4) extruding the expansion portions along the opposite direction of the first direction to expand the expansion portions toward the inner walls of the through hole, until the pressing section is stretched and the insertion section is prevented from being drawn from the through hole.

10. The assembly method according to claim 9, wherein in the step (4), an external object is inserted into the separation notch along the opposite direction of the first direction to extrude the separation notch, and the expansion portions are expanded due to the external object, until the expansion portions are pushed against the inner walls of the through hole.
